(19) United States
(12) Patent Application Publication
(10) Pub. No.: US 2013/0192873 A1
(43) Pub. Date: Aug. 1, 2013

(54) STRUCTURE BODY AND ELECTRONIC COMPONENT AND PRINTED WIRING BOARD INCLUDING THE SAME

(71) Applicant: TDK CORPORATION, Tokyo (JP)

(72) Inventors: Makoto ORIKASA, Tokyo (JP); Hideyuki SEIKE, Tokyo (JP); Noboru ITO, Tokyo (JP); Kenichi YOSHIDA, Tokyo (JP); Yuhei HORIKAWA, Tokyo (JP)

(73) Assignee: TDK CORPORATION, Tokyo (JP)

(21) Appl. No.: 13/678,107

(22) Filed: Nov. 15, 2012

(30) Foreign Application Priority Data
Jan. 27, 2012 (JP) 2012-015475
Nov. 14, 2012 (JP) 2012-250620

(51) Int. Cl. H01B 1/00

(52) U.S. Cl. CPC H01B 1/00
USPC 174/126.2

(57) ABSTRACT

This structure body includes a conductor comprising Cu as a main component, an intermediate layer formed on the conductor, and a protective layer formed on the intermediate layer, the intermediate layer includes at least Cu, Sn, Ni, and P, and the protective layer includes at least Ni and P.

### TECHNICAL FIELD

The present invention relates to a structure body and an electronic component and printed wiring board including the same.

### BACKGROUND

Conventionally, Cu has been widely used as conductors of electronic components and wiring patterns of printed wiring boards. However, because Cu is inferior in corrosion resistance, electroless plating has been increasingly applied to parts that require corrosion resistance and solder bonding. Especially, plating films that are formed by electroless Ni plating are excellent in corrosion resistance, and can also be applied to parts that require solder bonding.

A catalyst to promote precipitation is required for performing electroless Ni plating. Pd has been widely used as the catalyst.

However, use of a noble metal such as Pd poses a problem of corrosion due to a local cell reaction. For example, Patent Document 1 (Japanese Patent Application Laid-Open No. H09-130050) can be mentioned as a technique for preventing corrosion of a Cu wiring pattern. There has been proposed a technique for preventing corrosion of a Cu wiring pattern by forming on the Cu wiring pattern a metal layer having an ionization tendency larger than that of Cu and not larger than that of titanium.

### SUMMARY

However, as in the technique described in Patent Document 1, using as an interlayer a base metal having an ionization tendency larger than that of Cu poses a problem of a decrease in heat resistance, bonding strength, or corrosion resistance caused by formation of voids due to the Kirkendall effect or formation of a brittle alloy layer.

The present invention has been made in view of the above, and it is an object of the present invention to provide a structure body excellent in heat resistance, bonding strength, and corrosion resistance, without using a noble metal such as palladium, and an electronic component and printed wiring board including the structure body.

In order to solve the problems described above and achieve the object, a structure body of the present invention includes a conductor including Cu as a main component, an intermediate layer formed on the conductor, and a protective layer formed on the intermediate layer, in which the intermediate layer contains at least Cu, Sn, Ni, and P, and the protective layer contains at least Ni and P.

In the structure body comprising such an intermediate layer including Cu, Sn, Ni, and P, there is an effect that generation of voids due to the Kirkendall effect and a brittle alloy layer is suppressed. As a result, a structure body sufficiently excellent in bonding strength and corrosion resistance is obtained.

As a desirable mode of the present invention, it is preferable that the maximum value of the concentration of Sn contained in the intermediate layer is 5 (at. %) or more and 50 (at. %) or less. Note that the unit (at. %) denotes atomic percentage.

In this range of the Sn concentration, the advantageous effect of suppressing generation of voids due to the Kirkendall effect and a brittle alloy layer increases.

As a desirable mode of the present invention, it is preferable that an average value of the P concentration of the intermediate layer is smaller than an average value of the P concentration of the protective layer.

Making the P concentration of the intermediate layer lower than the P concentration of the protective layer provides an effect that diffusion of P proceeds easily toward the intermediate layer from the protective layer. With a structure where the P concentration of the intermediate layer is lower than that of the protective layer, P diffuses easily, and P suppresses diffusion of Sn to Ni and Cu, so that an advantageous effect that voids due to the Kirkendall effect can be further suppressed is obtained.

As a desirable mode of the present invention, it is preferable that the average value of the P concentration of the intermediate layer is 2 (at. %) or more and 19 (at. %) or less.

In the range of the P concentration of 2 (at. %) or more and 19 (at. %) or less, P diffuses more easily toward the intermediate layer from the protective layer. Therefore, as with the above, voids due to the Kirkendall effect can be further suppressed.

As a desirable mode of the present invention, it is preferable that the intermediate layer has a thickness in a range of 0.05 (μm) or more and 0.5 (μm) or less.

Setting the thickness of the intermediate layer to 0.05 (μm) or more and 0.5 (μm) or less provides an effect that diffusion of Sn in the intermediate layer is particularly suppressed, and generation of voids due to the Kirkendall effect in the intermediate layer is further suppressed. As a result, a structure body further excellent in bonding strength is obtained.

The thickness of the protective layer can be set to 0.1 (μm) or more and 5 (μm) or less. This is because the protective layer cannot be formed with a uniform thickness if the thickness thereof is smaller than the lower limit and excessively thin, and an excessively thick thickness exceeding the upper limit leads to an increase in manufacturing cost.

As a desirable mode of the present invention, for a use that requires solder wettability, it is preferable to form a surface electrode layer on the protective layer.

The surface electrode layer is excellent in solder wettability, and has an advantageous effect of being able to suppress oxidation of the protective layer.

The present invention also provides an electronic component and printed wiring board including the structure body described above. The electronic component and printed wiring board of the present invention have structures having the characteristics described above, and are therefore excellent in bonding strength and corrosion resistance.

Because the structure body comprising an intermediate layer including Cu, Sn, Ni, and P is suppressed from generation of voids due to the Kirkendall effect and a brittle alloy layer, a structure body superior in bonding strength and corrosion resistance can be provided.

### BRIEF DESCRIPTION OF DRAWINGS

FIG. 1 is a sectional view schematically showing a structure body which is the present embodiment.

FIG. 2 is a perspective view schematically showing an electronic component which is the present embodiment.

FIG. 3 is a sectional view schematically showing a sectional structure taken along a line I-I of FIG. 2.

FIG. 4 is a sectional view schematically showing a sectional structure of a printed wiring board which is the present embodiment.

FIG. 5 is a graph schematically showing a concentration profile (before heat resistance test) of elements in a sample section according to an example.

FIG. 6 is a view showing a sectional composition of a sample of a comparative example.

FIG. 7 is a graph schematically showing a concentration profile (before heat resistance test) of elements in a sample section according to a comparative example.

FIG. 8 is a view showing a scanning electron micrograph (SEM) of a sample according to an example after reflow treatment (heat resistance test).

FIG. 9 is a view showing a scanning electron micrograph (SEM) of a sample according to a comparative example after reflow treatment (heat resistance test).

### DESCRIPTION OF EMBODIMENTS

Embodiments of the present invention will be described in detail with reference to the drawings. The present invention is not limited to the contents to be described in the following embodiments. Moreover, constitutional elements to be described in the following include ones that can be easily conceived by those skilled in the art and ones that are substantially the same. Moreover, constitutional elements to be described in the following can be combined as appropriate.

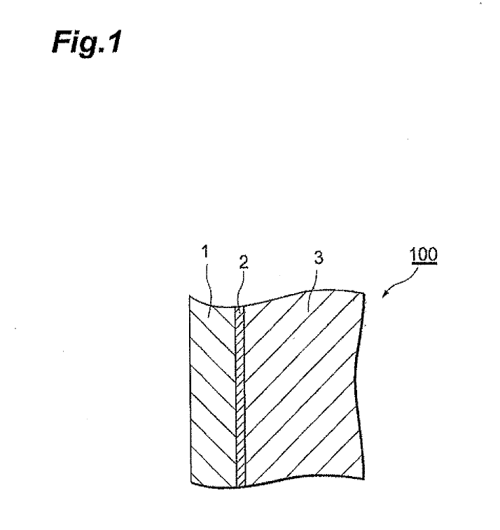

FIG. 1 is a sectional view schematically showing a structure body which is the present embodiment.

As shown in FIG. 1, for example, the structure body 100 is formed on the surface of a ceramic element assembly of an electronic component, a printed wiring board, or the like. The structure body 100 includes a conductor 3 containing Cu as a main component and includes thereon an intermediate layer 2 containing at least Cu, Sn, Ni, and P and a protective layer 1 containing at least Ni and P.

The conductor 3 is made of a material containing Cu as a main component. For example, the conductor 3 is formed by baking a Cu plating film formed by a wet plating method, a Cu paste, or a Cu conductive paste. If the conductor 3 contains a large glass component, adhesion decreases between the intermediate layer 2 and the conductor 3. It is therefore preferable that the glass component is as small as possible.

However, the method for forming the conductor 3 is not limited to the exemplified one.

The protective layer 1 contains at least Ni and P, and can be formed by, for example, electroless Ni plating using hypophosphorous acid as a reducing agent. The process for forming the protective layer 1 by electroless Ni plating uses, for example, a chloride or sulfate of Ni as an Ni element. The process further uses, for example, sodium hypophosphite as a reducing agent. In order to maintain the stability of the Ni plating solution, for example, citric acid, succinic acid, or malic acid may be added as a complexing agent. By dipping the conductor 3 in this aqueous solution, a protective layer 1 can be formed on the surface of the conductor 3.

An average value of the concentration of P contained in the protective layer 1 is preferably 12 (at. %) or more and 22 (at. %) or less, and more preferably 14 (at. %) or more and 19 (at. %) or less. A protective layer 1 excellent in corrosion resistance and abrasion resistance is obtained in this range.

The concentration of P contained in the protective layer 1 can be adjusted by, for example, changing the concentration of Ni contained in the electroless Ni plating solution, the concentration of hypophosphorous acid serving as a reducing agent therein, and the pH thereof. These may be changed alone, or changing these in a complex manner in combination allows obtaining protective layers 1 having various P concentrations.

The protective layer 1 functions, for example, as a shielding layer for preventing corrosion of the conductor 3 and for further preventing diffusion of a metal of the conductor 3 into a solder due to heat during soldering.

The intermediate layer 2 contains at least Cu, Sn, Ni, and P. Preferably Cu, Ni, and P to be contained in the intermediate layer 2 include a diffused component of the Cu contained in the conductor 3 and the Ni and P contained in the protective layer 1. Diffusion of Cu, Sn, Ni, and P can be facilitated by heating. The concentrations of Cu, Sn, Ni, and P contained in the intermediate layer 2 can therefore be adjusted by a heating condition. The heating condition is preferably 100° C. or more and 200° C. or less.

For example, for forming the intermediate layer 2, it suffices to form a layer made mainly of an Sn alloy and further form thereon a protective layer 1 containing at least Ni and P. When a layer made mainly of an Sn alloy is used, examples of the layer that can be used include Sn—Cu, Sn—Ni, Sn—Cu—Ni, and ones further containing P in these. Alternatively, the intermediate layer 2 can be formed by diffusion of Cu contained in the conductor 3 and either or both of the Ni and P contained in the protective layer 1 into a layer made mainly of Sn. The layer made mainly of an Sn alloy and the layer made mainly of Sn also contain impurities that have been unavoidably mixed.

The layer made mainly of an Sn alloy and the layer made mainly of Sn can be formed by a method such as a sputtering method, a vacuum deposition method, an electrolytic plating method, or an electroless plating method. At this time, by using a masking method such as a resist, a layer made mainly of an Sn alloy or a layer made mainly of Sn can be selectively formed on the conductor 3.

As a range of the concentration of Sn contained in the intermediate layer 2, its maximum value is preferably 5 (at. %) or more and 50 (at. %) or less, and more preferably 5 (at. %) or more and 40 (at. %) or less.

As the P concentration of the intermediate layer 2, it is preferable that its average value is smaller than that of the P concentration of the protective layer 1. Making the P concentration of the intermediate layer 2 lower than the P concentration of the protective layer 1 allows diffusion of P to proceed easily toward the intermediate layer 2 from the protective layer 1.

As the concentration of P contained in the intermediate layer 2, its average value is preferably 2 (at. %) or more and 19 (at. %) or less, and more preferably 2 (at. %) or more and 14 (at. %) or less.

The intermediate layer 2 may have a change in the concentrations of Cu, Ni, Sn, and P elements in its thickness direction. For example, the concentrations of Ni and P contained in the intermediate layer 2 may be lower as they are closer to an interface between the intermediate layer 2 and the conductor 3 from an interface between the protective layer 1 and the intermediate layer 2. When there is a change in the concentrations as in the above, it suffices to measure mean concentrations by an energy dispersive X-ray spectroscope attached to a scanning electron microscope and provide the same as the concentrations of Cu, Ni, Sn, and P elements contained in the intermediate layer 2. In addition, the concentration of Sn in the intermediate layer 2, a point of measurement in the thickness direction, does not exceed 50 at. % at the maximum at any measurement point.

The thickness of the intermediate layer 2 is preferably 0.05 (μm) or more and 0.5 (μm) or less, and more preferably 0.05 (μm) or more and 0.4 (μm) or less. Setting the thickness of the intermediate layer to 0.05 (μm) or more and 0.5 (μm) or less provides an effect that diffusion of Sn in the intermediate layer is particularly suppressed, and generation of voids due to the Kirkendall effect in the intermediate layer is further suppressed. As a result, a structure body further excellent in bonding strength is obtained.

Moreover, it is preferable that the thickness of the protective layer 1 is 0.1 (μm) or more and 5.0 (μm) or less. This is because the protective layer 1 cannot be formed with a uniform thickness if the thickness thereof is smaller than the lower limit and excessively thin, and an excessively thick thickness exceeding the upper limit leads to an increase in manufacturing cost.

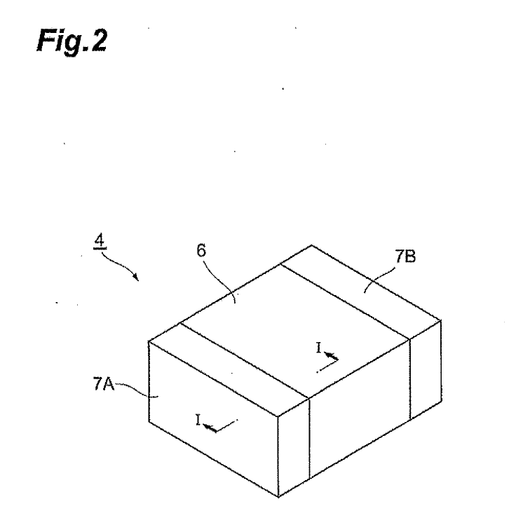

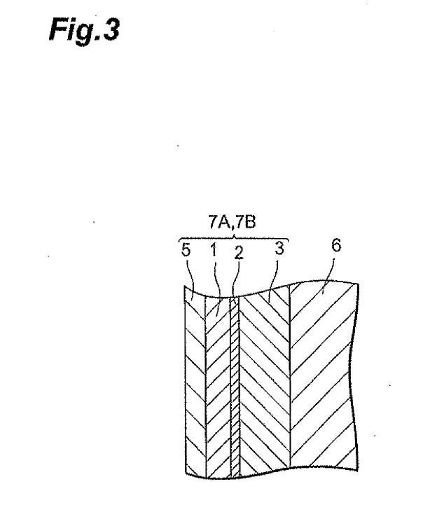

FIG. 2 and FIG. 3 are for explaining an electronic component 4 which is the present embodiment. Here, FIG. 2 is a perspective view showing the electronic component 4. FIG. 3 is a sectional view taken along a line I-I of FIG. 2.

As shown in FIG. 2, for the electronic component 4 of the present embodiment, external terminal electrodes 7A and 7B are formed at both end surfaces of a ceramic element assembly 6. As shown in FIG. 3, the external terminal electrode 7A, 7B includes a conductor 3 containing Cu as a main component, an intermediate layer 2 containing at least Cu, Sn, Ni, and P, a protective layer 1 containing at least Ni and P, and a surface electrode layer 5.

Examples of the ceramic element assembly 6 include a ceramic capacitor that is made of a dielectric ceramic material such as BaTiO₃, CaTiO₃, SrTiO₃, or CaZrO₃ and an inductor that is made of a ferrite material consisting of Fe₂O₃, Ni, Cu, and Zn. The ceramic element assembly 6 includes internal electrodes, and the internal electrodes are electrically connected with the external terminal electrodes 7A and 7B, and made of a metal such as Cu, Ni, Ag, or the like.

The surface electrode layer 5 is, for example, for imparting solder wettability, made of a material containing as a main component Sn, Au, or the like excellent in solder wettability. The surface electrode layer 5 is formed mainly by a wet plating method such as electrolytic plating or electroless plating.

Thus, by providing the intermediate layer 2 containing at least Cu, Sn, Ni, and P in between the conductor 3 and the protective layer 1 containing at least Ni and P, an electronic component excellent in bonding strength and corrosion resistance is obtained.

However, the above-described surface electrode layer 5 is not limited to the purpose described above, and also in constituent material, not limited to the exemplified ones.

Next, a printed wiring board according to another embodiment of the present invention will be described in the following.

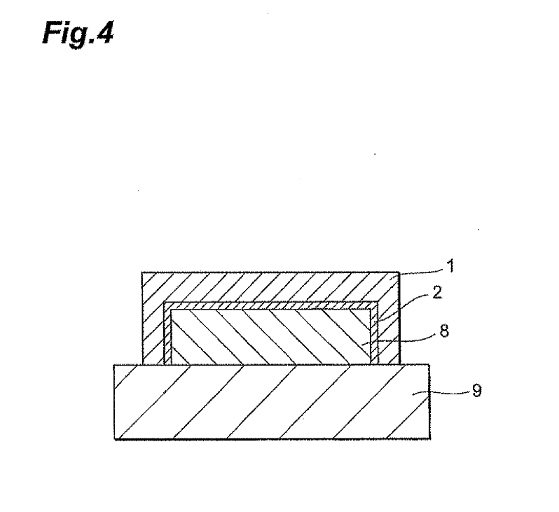

FIG. 4 is a sectional view schematically showing a sectional structure of a printed wiring board which is the present embodiment and its wiring pattern.

The wiring pattern 8 is formed on a substrate 9, and thereon an intermediate layer 2 containing at least Cu, Sn, Ni, and P and a protective layer 1 are provided.

The substrate 9 may be, for example, a resin substrate such as of an epoxy resin, and may be a glass-ceramic substrate.

The wiring pattern 8 is made of a material containing Cu as a main component, and can be formed directly on a substrate by, for example, a processing method of etching from a copper clad laminate, or by electrolytic plating or electroless plating.

The printed wiring board including the intermediate layer 2 and the protective layer 1 on the wiring pattern 8 is characterized by being excellent in bonding strength and corrosion resistance. For a use that further requires solder wettability, it suffices to form a surface electrode layer 5 on the protective layer 1.

Although preferred embodiments have been described above, the present invention is by no means limited to the above-described embodiments. For example, the above-described embodiments have been described by using an electronic component including external terminal electrodes formed on a ceramic element assembly and a printed wiring board, but the structure of the present invention may be provided for an object other than an electronic component and a printed wiring board.

Hereinafter, the contents of the present invention will be described in greater detail by means of examples and comparative examples, but the present invention is not limited to the following examples.

### EXAMPLES

### Examples 1 to 7

### [Fabrication of Evaluation Substrates]

As an object to be treated, a highly heat-resistant substrate (manufactured by Kansai Denshi Industry Co., Ltd., product name: FR-4 substrate, thickness: 0.8 mm) adhered with a copper foil having a thickness of 18 μm was used. This substrate was overcoated with a solder resist to form thereon a Cu wiring pattern of 6 mm×7 mm.

This substrate was dipped in isopropyl alcohol for ultrasonic cleaning for 1 minute, and further cleaned with distilled water for 1 minute. After applying electroless Sn plating (Sn methanesulfonate (25 g/L of Sn²⁺), methanesulfonic acid (25 g/L), and thiourea (150 g/L), the substrate was taken out and washed with water for 1 minute. By performing electroless Sn plating for 5 minutes for Example 1 and varying the electroless Sn plating time in Example 2 to Example 7, the thickness of Sn plating films was varied.

Electroless Ni plating (manufactured by Okuno Chemical Industries Co., Ltd.: ICP Nicoron SOF) was then performed to form a protective layer that is 3.0 μm on average. This substrate after electroless Ni plating was taken out, and washed with water for 1 minute. After dipping the electroless Ni-plated substrate in ethanol, a heat treatment (100° C.-200° C.: Table 1) was performed for 1 hour. In this way, an evaluation substrate for which an intermediate layer and a protective layer were formed on a Cu wiring pattern was prepared. Observation of a section of the evaluation substrate was performed, and the section was confirmed in a 5000× field of view by a scanning electron microscope (SEM) to measure the thicknesses of the respective layers.

(Evaluation)

Next, an evaluation test of the fabricated evaluation substrates was performed.

The evaluation substrates prepared for an external appearance evaluation were left standing for 1000 hours at 60° C. or more and 62° C. or less and a humidity of 90% or more and 95% or less, and an external appearance after 1000 hours was evaluated. The external appearance was observed by enlarging the evaluation substrate at a magnification of 100 times with use of a magnifying glass, and one without discoloration was marked by G (good), and one with discoloration was marked by B (bad).

Sectional observation of the evaluation substrates prepared for concentration measurement was performed to measure the P concentration of the protective layer, the P concentration of the intermediate layer, and the Sn concentration of the intermediate layer. For the measurement of each concentration, analysis was performed by an energy dispersive X-ray spectroscope (EDS) attached to a scanning electron microscope (SEM), and 5 arbitrary spots were measured to determine an average value.

For evaluating heat resistance, a reflow treatment was performed for the evaluation substrates prepared for void observation. Observation of sections of the evaluation substrates was performed to confirm whether voids have occurred. The sections were mirror polished, and the sections were confirmed in a 5000× field of view by a scanning electron microscope (SEM), and one without generation of voids was marked by V (very good), one with generation of voids less than 100 nm was marked by G, and one with generation of voids of 100 nm or more was marked by B. As the condition for the reflow treatment (heat resistance test), the preheating time was set to 60 seconds or more and 90 seconds or less, the time for which it is 220° C. or more was set to 30 seconds or more and 40 seconds or less, and the peak temperature was set to 230° C. or more and 255° C. or less.

For evaluating tensile strength, a reflow treatment was performed for the evaluation substrates prepared for tensile strength testing. The tensile strength was measured by fixing a stud pin with an epoxy adhesive (diameter of 2.7 mm, length of 12.7 mm) manufactured by Quad Corporation to the top of the protective layer of the evaluation substrate at 150° C. for 1 hour, and pulling the same vertically. The measurement was performed five times (n=5) to determine an average value of the strength and observe the mode of peeling. One having a strength of 20N or more and with the occurrence of peeling at an adhesion interface between the stud pin and protective layer was marked by G, and one with 20N or less and with the occurrence of peeling between the protective layer and Cu pattern was marked by B.

The results of Examples 1 to 7 thus obtained are shown in Table 1. In Table 1, the P concentration shows an average value in each layer, the Sn concentration shows the maximum value in each layer, and the thickness shows an average value in each layer.

### Example 8

The same substrate as that of Examples 1 to 7 was dipped in isopropyl alcohol for ultrasonic cleaning for 1 minute, and further cleaned with distilled water for 1 minute. After forming a layer of Sn—Ni—P by electroless plating (Ni²⁺: 6 g/L, Sn²⁺: 5 g/L, hypophosphorous acid: 7 g/L, complexing agent, pH8, 80° C.), the substrate was taken out and washed with water for 1 minute.

Electroless Ni plating (manufactured by Okuno Chemical Industries Co., Ltd.: ICP Nicoron SOF) was then performed to form a protective layer that is 3.0 μm on average. This substrate after electroless Ni plating was taken out, and washed with water for 1 minute. After dipping the electroless Ni-plated substrate in ethanol, a heat treatment (150° C.: Table 1) was performed for 1 hour. In this way, an evaluation substrate for which an intermediate layer and a protective layer were formed on a Cu wiring pattern was prepared.

The same evaluation as that of Example 1 to Example 7 was performed. The obtained results of Example 8 are shown in Table 1.

### Examples 9 to 12

The same substrate as that of Examples 1 to 7 was dipped in isopropyl alcohol for ultrasonic cleaning for 1 minute, and further cleaned with distilled water for 1 minute. After applying electrolytic Sn plating (NBRZ, manufactured by Ishihara Chemical Co., Ltd.), the substrate was taken out and washed with water for 1 minute. By performing electrolytic Sn plating for 5 minutes in Example 9 and varying the electrolytic Sn plating time in Example 10 to Example 12, the thickness of Sn plating films was varied.

Electroless Ni plating (manufactured by Okuno Chemical Industries Co., Ltd.: ICP Nicoron SOF) was then performed to form a protective layer that is 3.0 μm on average. This substrate after electroless Ni plating was taken out, and washed with water for 1 minute. After dipping the electroless Ni-plated substrate in ethanol, a heat treatment (105° C.-185° C.: Table 1) was performed for 1 hour. In this way, an evaluation substrate for which an intermediate layer and a protective layer were formed on a Cu wiring pattern was prepared.

The same evaluation as that of Example 1 to Example 7 was performed. The obtained results of Examples 9 to 12 are shown in Table 1.

### Examples 13 to 17

The same substrate as that of Examples 1 to 7 was dipped in isopropyl alcohol for ultrasonic cleaning for 1 minute, and further cleaned with distilled water for 1 minute. Masking was provided so as to leave only the Cu pattern, and an Sn film was formed only on the Cu pattern by an Ar sputtering method using Sn as the target. By varying the sputtering time, the thickness of Sn plating films was varied.

Electroless Ni plating (manufactured by Okuno Chemical Industries Co., Ltd.: ICP Nicoron SOF) was then performed to form a protective layer that is 3.0 μm on average. This substrate after electroless Ni plating was taken out, and washed with water for 1 minute. After dipping the electroless Ni-plated substrate in ethanol, a heat treatment (100° C.˜185° C.: Table 1) was performed for 1 hour. In this way, an evaluation substrate for which an intermediate layer and a protective layer were formed on a Cu wiring pattern was prepared.

The same evaluation as that of Example 1 to Example 7 was performed. The obtained results of Examples 13 to 17 are shown in Table 1.

### Examples 18 to 21

In Examples 18 to 21, an Sn plating film to serve as an intermediate layer was formed on a conductor made of Cu by the same process as that of Examples 1 to 7. The thickness of the Sn plating film is 0.10 μm to 0.23 μm.

Then, an electroless Ni plating film (protective layer) was formed on the Sn plating film by the same process as that of Examples 1 to 7. By varying the plating time, the thickness of the protective layer was changed to 0.1 μm to 2.0 μm. This substrate after electroless Ni plating was taken out, and washed with water for 1 minute. After dipping the electroless Ni-plated substrate in ethanol, a heat treatment (105° C.: Table 1) was performed for 1 hour. In this way, an evaluation substrate for which an intermediate layer and a protective layer were formed on a Cu wiring pattern was prepared. In addition, because the function of protective layers is protection, it is considered that the same results will be obtained, at least, if their thicknesses are 5.0 μm or less.

The same evaluation as that of Example 1 to Example 7 was performed. The obtained results of Examples 18 to 21 are shown in Table 1.

### Comparative Examples 1 to 3

Furthermore, for the purpose of comparison, the same substrate as that of Examples 1 to 7 was dipped in isopropyl alcohol for ultrasonic cleaning for 1 minute, and further cleaned with distilled water for 1 minute. After applying the same electrolytic Sn plating as that of Example 9, the substrate was taken out and washed with water for 1 minute. By performing electrolytic Sn plating for 20 minutes in Comparative example 1, performing electrolytic Sn plating for 35 minutes in Comparative example 2, and performing electrolytic Sn plating for 50 minutes in Comparative example 3, the thickness of Sn plating films was varied.

Then, the same electroless Ni plating as that in Example 1 was performed to form a protective layer that is 3.0 μm on average. This substrate after electroless Ni plating was taken out, and washed with water for 1 minute. After dipping the electroless Ni-plated substrate in ethanol, a heat treatment was performed for 1 hour at the same temperature as that in Example 1. In this way, evaluation substrates of comparative examples 1 to 3 were fabricated. The same evaluation as that of Examples 1 to 7 was performed. Because there were formed a plurality of alloy layers in Comparative example 1 to Comparative example 3 instead of forming an intermediate layer, the thickness of the alloy layers was measured collectively.

The same evaluation as that of Example 1 to Example 7 was performed. The obtained results of Comparative examples 1 to 3 are shown in Table 1. Examples 1 to 20 are denoted by Ex 1 to Ex 20, Comparative Examples 1 to 3 are denoted by Com 1 to Com 3.

TABLE 1

| | | | Protective | Intermediate | Intermediate | | | Heat | | | |
|---|---|---|---|---|---|---|---|---|---|---|---|
| | Intermediate | Protective | layer P | layer P | layer Sn | Alloy layer | Alloy layer | treatment | | External | Tensile |
| | layer (μm) | layer (μm) | (at. %) | (at. %) | (at. %) | (μm) | Sn (at. %) | (C.°) | Void | appearance | strength |
| Ex 1 | 0.05 | 3.0 | 19.0 | 11.0 | 29.0 | — | — | 100 | V | G | G |
| Ex 2 | 0.10 | 3.0 | 21.8 | 18.8 | 19.0 | — | — | 150 | V | G | G |
| Ex 3 | 0.09 | 3.0 | 13.0 | 12.0 | 5.0 | — | — | 200 | V | G | G |
| Ex 4 | 0.09 | 3.0 | 13.6 | 2.9 | 25.0 | — | — | 110 | V | G | G |
| Ex 5 | 0.32 | 3.0 | 12.6 | 3.6 | 35.5 | — | — | 120 | V | G | G |
| Ex 6 | 0.40 | 3.0 | 13.0 | 3.0 | 39.9 | — | — | 100 | V | G | G |
| Ex 7 | 0.50 | 3.0 | 13.0 | 2.2 | 49.6 | — | — | 100 | G | G | G |
| Ex 8 | 0.08 | 3.0 | 13.6 | 13.4 | 8.3 | — | — | 150 | V | G | G |
| Ex 9 | 0.12 | 3.0 | 12.6 | 2.6 | 33.0 | — | — | 105 | V | G | G |
| Ex 10 | 0.15 | 3.0 | 13.0 | 6.1 | 12.0 | — | — | 158 | V | G | G |
| Ex 11 | 0.18 | 3.0 | 13.0 | 8.0 | 11.0 | — | — | 185 | V | G | G |
| Ex 12 | 0.23 | 3.0 | 12.6 | 3.6 | 24.5 | — | — | 120 | V | G | G |
| Ex 13 | 0.08 | 3.0 | 12.6 | 3.4 | 26.5 | — | — | 118 | V | G | G |
| Ex 14 | 0.09 | 3.0 | 12.6 | 7.3 | 18.3 | — | — | 175 | V | G | G |
| Ex 15 | 0.12 | 3.0 | 13.0 | 6.0 | 16.5 | — | — | 155 | V | G | G |
| Ex 16 | 0.14 | 3.0 | 13.0 | 2.2 | 15.7 | — | — | 100 | V | G | G |
| Ex 17 | 0.15 | 3.0 | 12.6 | 2.6 | 25.4 | — | — | 105 | V | G | G |
| Ex 18 | 0.10 | 0.1 | 12.0 | 2.0 | 39.6 | — | — | 105 | V | G | G |
| Ex 19 | 0.23 | 0.5 | 12.6 | 3.6 | 22.8 | — | — | 120 | V | G | G |
| Ex 20 | 0.15 | 1.0 | 12.6 | 2.6 | 25.2 | — | — | 105 | V | G | G |
| Ex 21 | 0.15 | 2.0 | 12.6 | 2.6 | 24.8 | — | — | 105 | V | G | G |
| Com 1 | — | 3.0 | 13.0 | — | | 0.68 | 65 | 100 | B | B | B |
| Com 2 | — | 3.0 | 13.0 | — | | 1.06 | 85 | 100 | B | B | B |
| Com 3 | — | 3.0 | 13.0 | — | | 1.22 | 92 | 100 | B | B | B |

From Table 1, there is considered to be no problem in Example 1 to Example 21 because peeling has occurred at an adhesion interface between the stud pin and protective layer and the tensile strength is 20N or more in all examples. This is because the Cu element, Ni element, and P element suppressed ununiform diffusion of the Sn element so that formation of voids due to the Kirkendall effect was suppressed. Voids having a diameter of 10 nm could be confirmed in Example 7, but there is considered to be no practical problem because the tensile strength is 20N or more. Furthermore, discoloration and the like due to corrosion of Cu was not found by observation of the external appearance, so that it was confirmed that there is no problem with corrosion resistance in Example 1 to Example 21.

On the other hand, in Comparative example 1 to Comparative example 3, voids have occurred inside the alloy layers, and the bonding strength has decreased. As for the mode of peeling, peeling has occurred inside the alloy layers, and this was caused by voids due to the Kirkendall effect. Furthermore, discoloration due to corrosion of Cu was found by observation of the external appearance.

Moreover, in Comparative example 1 to Comparative example 3, alloy layers of high Sn concentration exist, but an intermediate layer of low Sn concentration does not exist. The intermediate layers of the examples contain Sn at 5 (at. %) or more and 50 (at. %) or less (maximum value in the layer), and there are satisfactory results obtained by an evaluation of the external appearance and voids.

Moreover, in any of Examples 1 to 21, the P concentration of the intermediate layer is lower than the P concentration of the protective layer (an average value in the layer).

Moreover, in any of Examples 1 to 21, the intermediate layer contains P at 2 (at. %) or more and 19 (at. %) or less (an average value in the layer).

Moreover, in any of Examples 1 to 21, the thickness of the intermediate layer is 0.05 μm or more and 0.5 μm or less.

Moreover, in any of Examples 1 to 21, the thickness of the protective layer is 0.1 μm or more and 5 μm or less.

In addition, the thicknesses of the intermediate layers and protective layers in Table 1 are thicknesses after the 1-hour heat treatment described above. After the heat treatment, the thickness of the intermediate layers (Cu—Sn—Ni—P alloys) increases and the thickness of the protective layers (Ni—P alloys) decreases. There are differences in the thicknesses of the intermediate layers and protective layers between before and after the heat treatment, but the intermediate layers were 0.05 μm or more and 0.5 μm or less and the protective layers were 0.1 μm or more and 5.0 μm or less in thickness both before and after the treatment.

Sections of the fabricated substrates were analyzed by an SEM-EDS (SEM: Scanning Electron Microscope, EDS: Energy Dispersive X-ray Spectroscopy) system.

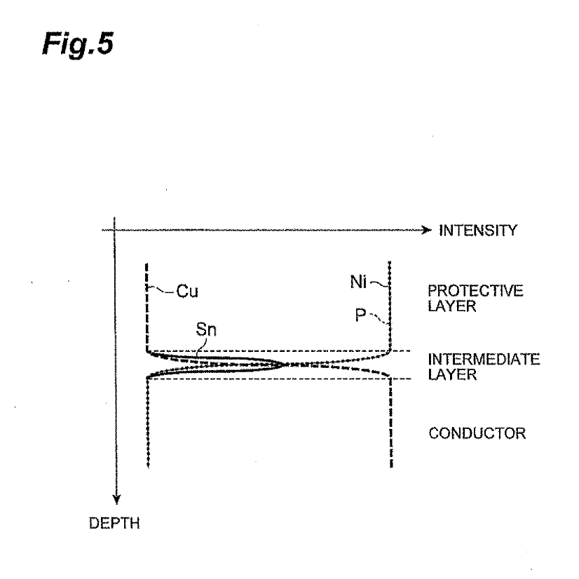

FIG. 5 is a graph schematically showing a concentration profile (before heat resistance test) of elements in a sample section according to an example. The concentrations of the elements are shown by EDS intensities.

A point measurement of the sample section is performed in the depth direction shown in FIG. 5 to identify the respective layers based on change, points in the element profile. First, a region where the concentrations of Cu and Sn indicate a low constant value as well as the concentrations of Ni and P have a constant value and are high, that is, a region formed mostly of Ni and P is identified as a protective layer. As it moves in the depth direction, a region appears where the concentration of Sn eventually begins to increase, reaches a peak near a central portion, and then again decreases. Moreover, in this region, the concentrations of Cu also gradually increase as it moves in the depth direction, while the concentrations of Ni and P gradually decrease as it moves in the depth direction. Thus, a region from a beginning point where a concentration change of 1% or more appears from the concentrations of constant values in the protective layer in terms of all of the concentrations of Sn, Cu, Ni, and P to an end point to again have the concentrations of constant values in a conductor is judged to be an intermediate layer in the present invention. Then, when it moves further in the depth direction from the intermediate layer, it reaches a region where almost no Ni, P, and Sn exist, the concentrations thereof have low constant values, while the concentration of Cu has a constant value and is high, that is, a region formed mostly of Cu. This region corresponds to a conductor.

Here, in any example, the maximum concentration value of Sn in the intermediate layer was 50 (at. %) or less.

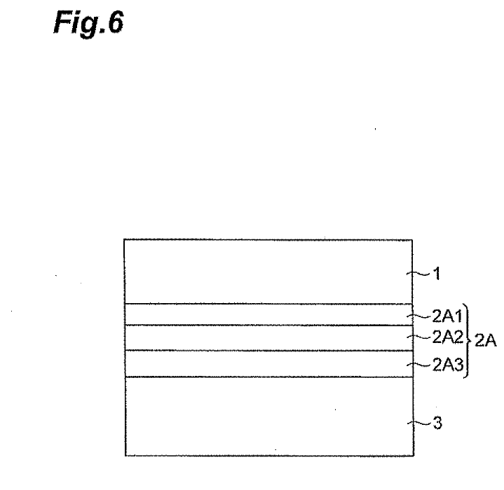

FIG. 6 is a view showing a sectional composition of a sample (before heat resistance test) of a comparative example.

On a conductor 3, there is sequentially formed a Cu—Sn alloy layer 2A3, an Sn-rich layer 2A2, and an Ni—P—Sn alloy layer 2A1, and there is a protective layer 1 formed thereon.

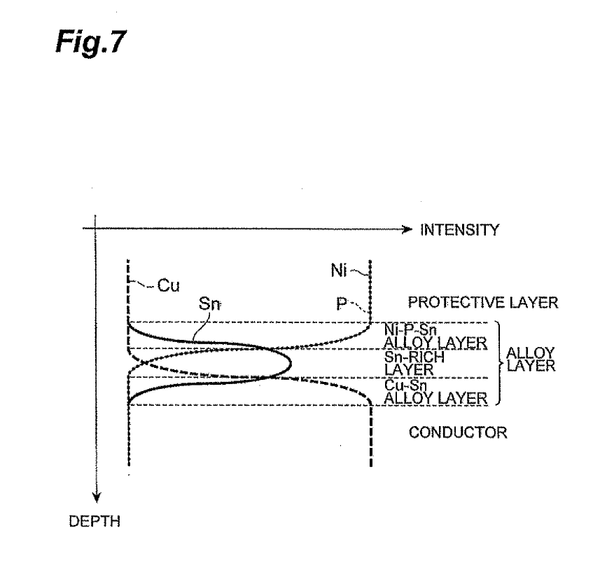

FIG. 7 is a graph schematically showing a concentration profile (before heat resistance test) of elements in a sample section according to a comparative example. The concentrations are shown by EDS intensities.

A point measurement of the sample section is performed in the depth direction shown in FIG. 7 to identify the respective layers based on change points in the element profile. First, a region where the concentrations of Cu and Sn indicate a low constant value as well as the concentrations of Ni and P have a constant value and are high, that is, a region formed mostly of Ni and P is identified as a protective layer. As it moves in the depth direction, a region appears where the concentration of Sn eventually begins to increase, takes a peak near a central portion, and then again decreases. However, there is a difference from the intermediate layer shown in FIG. 5 which is of an example in that a region where the concentration of Cu remains at a low constant value, that is, a region considered to be an alloy of Ni—P—Sn is recognized near where Sn begins to increase. Furthermore, in a region until the concentration of Sn decreases and reaches a low constant value, a region where the concentrations of Ni and P remain at a low constant value, that is, a region considered to be an alloy of Cu—Sn is also recognized. Thus, even a region where the concentration of Sn changes, when the region is judged to have inside a region of an Ni—P—Sn alloy and a region of a Cu—Sn alloy, is distinguished as an alloy layer from the intermediate layer of the example.

Also in the alloy layer region, similar to the intermediate layer, the concentration of Cu increases as it moves in the depth direction, and the concentrations of Ni and P also decrease as it moves in the depth direction similarly to the intermediate layer. The concentrations of Ni and P and Cu and Sn in the respective regions of a protective layer and conductor can be said to be the same between when an alloy layer is formed and when an intermediate layer is formed.

For judging whether there is formed an alloy layer or there is formed an intermediate layer, a judgment can be made by thus checking the Cu, Ni, and P concentrations near the points of beginning and ending of a concentration change of Sn, but a more distinct criterion for a judgment is to check whether the concentration of Sn is 50 at. % or less as mentioned above. In the case of being such a region that the Sn concentration exceeds 50 at. %, the concentrations of Cu and Ni and P in that region are relatively low as compared with when the Sn concentration is 50 at. % or less. This is because, when the Sn concentration exceeds 50 at. %, the concentrations of Cu and Ni and P are low relative to the Sn concentration, so that an effect of suppressing diffusion of Sn decreases, a Cu—Sn alloy layer is formed in a region close to the conductor, and an Ni—Sn alloy layer (Ni—P—Sn alloy layer) is formed in a region close to the protective layer.

That is, in any of Comparative examples 1 to 3, the maximum concentration value of Sn in the alloy layer was over 50 (at. %). Moreover, the conductor contained Cu as a main component, the alloy layer contained the respective elements (Cu, Sn, Ni, P) in its Sn-rich layer, and the protective layer contained only Ni and P. As shown in Table 1, the maximum values of the Sn concentrations in the alloy layers of Comparative examples 1, 2, and 3 were 65 at. %, 85 at. %, and 92 at. %, respectively.

On the other hand, the maximum values of the Sn concentrations in the alloy layers of Examples 1 to 21 were 5.0 at. % to 49.6 at. %. That is, in the examples, the intermediate layers contain Sn at 5 at. % or more and 50 at. % or less when the first decimal places are rounded off. Moreover, in the examples, the intermediate layers contain P at 2 at. % or more and 19 at. % or less when the first decimal places are rounded off (average values).

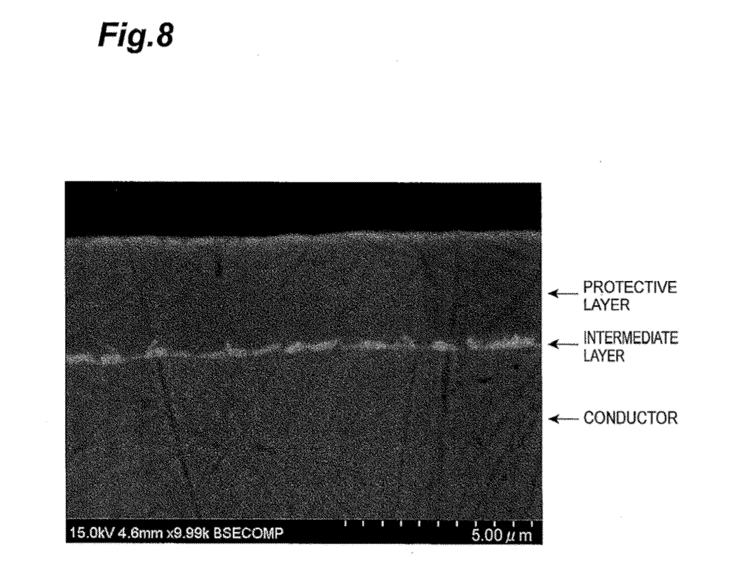

FIG. 8 is a view showing a scanning electron micrograph (SEM) of a sample according to Example 1 after reflow treatment (heat resistance test).

There is a protective layer formed on a conductor via an intermediate layer. In any example, there is a protective layer formed on a conductor via an intermediate layer. Moreover, no voids have occurred in the substrate.

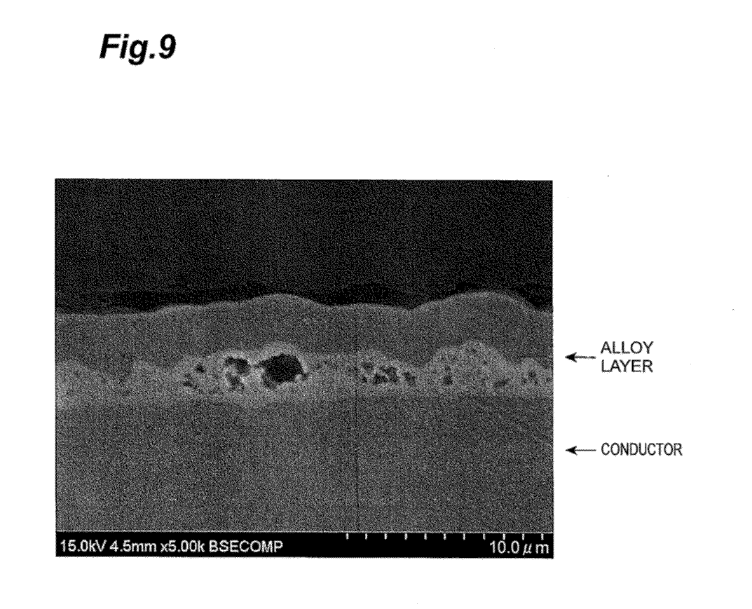

FIG. 9 is a view showing a scanning electron micrograph (SEM) of a sample according to Comparative example 1 after reflow treatment (heat resistance test).

There is an alloy layer and a protective layer formed on a conductor. In any comparative example, voids have occurred in the alloy layer after reflow.

As in the above, the structure body according to the present invention is suppressed from voids and Cu corrosion, and is excellent in heat resistance, bonding strength, and corrosion resistance.

What is claimed is:

1. A structure body comprising:
a conductor including Cu as a main component;
an intermediate layer formed on the conductor; and
a protective layer formed on the intermediate layer, wherein
the intermediate layer includes at least Cu, Sn, Ni, and P, and
the protective layer includes at least Ni and P.

2. The structure body according to claim 1, wherein a maximum value of the Sn concentration of the intermediate layer is 5 (at. %) or more and 50 (at. %) or less.

3. The structure body according to claim 1, wherein an average value of the P concentration of the intermediate layer is smaller than an average value of the P concentration of the protective layer.

4. The structure body according to claim 2, wherein an average value of the P concentration of the intermediate layer is smaller than an average value of the P concentration of the protective layer.

5. The structure body according to claim 3, wherein the average value of the P concentration of the intermediate layer is 2 (at. %) or more and 19 (at. %) or less.

6. The structure body according to claim 4, wherein the average value of the P concentration of the intermediate layer is 2 (at. %) or more and 19 (at. %) or less.

7. The structure body according to claim 1, wherein the intermediate layer has a thickness of 0.05 μm or more and 0.5 μm or less.

8. The structure body according to claim 1, wherein the protective layer has a thickness of 0.1 μm or more and 5 μm or less.

9. The structure body according to claim 1, further comprising a surface electrode layer formed on the protective layer.

10. An electronic component comprising the structure body according to claim 1.

11. A printed wiring board comprising the structure body according to claim 1.
